(19) United States
(12) Patent Application Publication
(10) Pub. No.: US 2007/0237109 A1
(43) Pub. Date: Oct. 11, 2007

(54) Mobile Communication System, Radio Base Station Device, Radio Network Control Device, Mobile Communication Method and Mobile Communication Program

(75) Inventors: Kenichiro Iida, Kanagawa (JP); Akito Fukui, Kanagawa (JP); Takeshi Kanazawa, Kanagawa (JP); Tomojumi Tamura, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/575,456

(22) PCT Filed: Sep. 13, 2005
(86) PCT No.: PCT/JP05/16857

§ 371 Date: Mar. 16, 2007

(30) Foreign Application Priority Data
Sep. 17, 2004 (JP) 2004-271893

(51) Int. Cl. H04Q 7/38; H04Q 7/00

(52) U.S. Cl. 370/328; 455/414.1

(57) ABSTRACT

There is provided a mobile communication system capable of improving the throughput. In this system, a radio base station device (1022) waits for an upstream retransmission packet for a predetermined period of time before the moment when the retransmission time out expiration time has come and transmits a retransmission wait release request to a radio network control device (1031). When the radio base station device (1022) receives a retransmission wait release response instructing to stop the retransmission wait from the radio network control device (1031), it stops wait for the upstream packet retransmission. When the radio network control device (1031) has confirmed that the upstream packet has been received from another radio base station device upon reception of the retransmission wait release request, it creates the retransmission wait release response instruction stop of the retransmission wait and transmits it to the radio base station device (1022).

### TECHNICAL FIELD

The present invention relates to a mobile communication system equipped with a plurality of mobile communication terminal devices, a plurality of radio base station devices that perform radio communication with the mobile communication terminal devices, and a radio network control device that controls the plurality of the plurality mobile communication terminal devices.

### BACKGROUND ART

FIG. 1 shows a conventional mobile communication system (see non-patent document 1). This conventional mobile communication system 10 uses an HSUPA (High Speed Uplink Packet Access) scheme (also known as an FDD Enhanced Uplink for UTRA) (see non-patent document 2).

As shown in FIG. 1, conventional mobile communication system 10 is equipped with a plurality of mobile communication terminal devices 11, a plurality of radio base station devices 21 to 24, and a plurality of radio network control devices 31 and 32, and core network 41. In FIG. 1, only one mobile communication terminal device 11 is shown.

Each of the plurality of radio base station devices 21 to 24 forms a radio area. Each of the plurality of radio base station devices 21 to 24 performs radio communication with mobile communication terminal device 11 positioned in each of the radio areas. Each of the plurality of radio network control devices 31 and 32 controls the plurality of radio base station devices 21 to 24.

Each of the plurality of radio network control devices 31 and 32 processes packets from the plurality of radio base station devices 21 to 24 and supplies processed packets to core network 41. Core network 41 performs position management and call control of mobile communication terminal device 11.

FIG. 2 shows an example of a user plane protocol configuration in HSUPA (High Speed Uplink Packet Access) used in conventional mobile communication system 10.

The following will explain an example of conventional mobile communication system 10 with reference to FIG. 1 and FIG. 3. FIG. 3 is a sequence diagram to explain an example of operations of conventional mobile communication system 10.

As shown in FIG. 3, when mobile communication terminal device 11 is in a soft hand-over state between radio base station device 21 and radio base station device 22, mobile communication terminal device 11 transmits packets P1 to both radio base station device 21 and radio base station device 22.

When radio base station device 21 and radio base station device 22 receive the packets P1 normally, they transmit ACK11 and ACK12 to mobile communication terminal device 11 and transfer the received packets P1 to radio network control device 31. When radio network control device 31 receives the packets P1 from radio base station device 21 and radio base station device 22, it transfers the packets P1 to core network 41 upon performing selection and combining processing on these packets P1.

Next, after mobile communication terminal device 11 receives ACK11 and ACK12, it transmits packets P2 to both radio base station device 21 and radio base station device 22.

Here, if radio base station device 21 receives the packets P2 normally yet radio base station device 22 does not receive the packets P2 normally, radio base station device 21 transmits ACK21 to mobile communication terminal device 11 and transfers the packets P2 to radio network control device 31.

On the other hand, radio base station device 22 transmits NACK22 to mobile communication terminal device 11, and, from that point, enters a retransmission wait state for the packets P2 while using processes for packets P2. Radio network control device 31 receives the packets P2 only from radio base station device 21 but performs a selection combing process targeting only the packets P2 that it could receive, and transfers the packets P2 to core network 41.

Here, if the radio link between mobile communication terminal device 11 and radio base station device 22 is disconnected, mobile communication terminal device 11 transmits packets P3 to both radio base station device 21 and radio base station device 22 after receiving ACK21 and ACK22.

Radio base station device 21 processes the packets P3 with the same processes as packets P1 and packets P2.

On the other hand, because the packets P2 reach radio network control device 31 via radio base station device 21, radio base station device 22 cannot receive the packets P3 regardless of the situation where it does not need to wait for retransmission packets P2, and continues the wait state for the packets P2 with the process occupying for retransmission of packet P2. Thereafter as well, after the status of radio base station device 22 has entered a retransmission wait state for packet P2, the same status continues until a retransmission timeout expiry time T51 passes.

Also, at the point the retransmission timeout expiry time T51 had passed, radio base station device 22 ends the retransmission wait for the packets P2 and releases the process occupied for the retransmission wait for the packets P2.

Note that mobile communication terminal device 11 implements the soft hand-over by connecting to more than three of the plurality of radio base station devices.

Non-patent document 1: 3GPP, TS25.401 UTRAN overall description, V5.7.0

Non-patent document 2: 3GPP, TR25.896 Feasibility Study for Enhanced Uplink for UTRA FDD (Release 6), V6.0.0

### DISCLOSURE OF THE INVENTION

### Problems to be Solved by the Invention

In a conventional mobile communication system, if a radio link between mobile communication terminal device 11 and radio base station device 22 is temporarily disconnected while mobile communication terminal device 11 is executing a soft handover between radio base station device 21 and radio base station device 22, radio base station device 22 cannot release the retransmission wait for the packets P2 process until the retransmission timeout expiry time T51 passes.

This is because the packets P2 reach radio network control device 31 via radio base station device 21, so that radio base station device 22 continues waiting to retransmit the packets P2 until the retransmission timeout expiry time passes, regardless of the situation where it is not necessary to retransmit the packets P2.

For that reason, in the conventional mobile communication system, because it is not possible to assign a process that performs a useless retransmission wait during the retransmission timeout expiry time T51, this invites the problem of lower throughput in radio base station device 22.

It is therefore an object of the present invention to provide a mobile communication system, radio base station device, radio network control device, mobile communication method and mobile communication program that can improve throughput.

Means of Solving the Problem

The mobile communication system of the present invention employs a configuration having: a plurality of mobile communication terminal devices; a plurality of radio base station devices that perform radio communications with the mobile communication terminal devices; and a radio network control device that controls the plurality of radio base station devices, and, in this mobile communication system, the radio base station devices transmit a retransmission wait cancellation request that requests a cancellation of a retransmission wait before a retransmission timeout expiry time passes during a retransmission wait for uplink retransmission packets, and stops the retransmission wait upon receiving a retransmission wait cancellation acknowledgment that specifies a stop of the retransmission wait; and the radio network control device transmits the retransmission wait cancellation acknowledgment to a radio base station device that transmitted the retransmission wait cancellation request when an uplink retransmission packet specified by the retransmission wait cancellation request has been received from another radio base station device other than the radio base station device that transmitted the retransmission wait cancellation request.

The radio base station device of the present invention employs a configuration having: a retransmission wait cancellation request section that transmits a retransmission wait cancellation request that requests a cancellation of a retransmission wait before a retransmission timeout expiry time passes during a retransmission wait for uplink retransmission packets; and a retransmission wait stopping section that stops the retransmission wait upon receiving a retransmission wait cancellation acknowledgement that specifies a stop of the retransmission wait in response to the retransmission wait cancellation request transmitted by the retransmission wait cancellation request section.

The radio network control device of the present invention employs a configuration having: a packet check section that, upon receiving a retransmission cancellation request that requests a cancellation of a retransmission wait for uplink retransmission packets, checks whether a packet specified by the retransmission wait cancellation request has been received from another radio base station device other than the radio base station device that transmitted the retransmission wait cancellation request; and a retransmission wait cancellation acknowledgment section that transmits a retransmission wait cancellation acknowledgment that specifies a stop of the retransmission wait to the radio base station device that transmitted the retransmission wait cancellation request when the packet check section checks that the uplink retransmission packet has been received from another radio base station device.

The mobile communication method of the present invention includes the steps of: transmitting from a base station device a retransmission wait cancellation request that requests a cancellation of a retransmission wait before a retransmission timeout expiry time passes during a retransmission wait for uplink retransmission packets; receiving at a radio network control device the retransmission wait cancellation request and checking whether an uplink retransmission packet specified by the received retransmission wait cancellation request has been received from another radio base station device other than the radio base station device that transmitted the retransmission wait cancellation request; transmitting, when it is checked that the uplink retransmission packet has been received from the another radio base station device, from the radio network control device a retransmission wait cancellation acknowledgment that specifies a stop of the retransmission wait to the radio base station device that transmitted the retransmission wait cancellation request; and receiving at the radio base station device the retransmission wait cancellation acknowledgment and stopping the retransmission wait.

The mobile communication program of the present invention executes the steps of: transmitting from a base station device a retransmission wait cancellation request that requests a cancellation of a retransmission wait before a retransmission timeout expiry time passes during a retransmission wait for uplink retransmission packets; receiving at a radio network control device the retransmission wait cancellation request and checking whether an uplink retransmission packet specified by the received retransmission wait cancellation request has been received from another radio base station device other than the radio base station device that transmitted the retransmission wait cancellation request; transmitting, when it is checked that the uplink retransmission packet has been received from the another radio base station device, from the radio network control device a retransmission wait cancellation acknowledgment that specifies a stop of the retransmission wait to the radio base station device that transmitted the retransmission wait cancellation request; and receiving at the radio base station device the retransmission wait cancellation acknowledgment and stopping the retransmission wait.

Advantageous Effect of the Invention

According to the present invention, throughput is improved because the invention prevents useless uplink packet retransmission wait.

### BRIEF DESCRIPTION OF THE DRAWINGS

FIG. 1 is a block diagram showing a configuration of a conventional mobile communication system;

FIG. 2 shows an example of a user plane protocol in HSUPA used in the conventional mobile communication system;

FIG. 3 is a sequence diagram to explain an example of operations of the conventional mobile communication system;

FIG. 4 is a block diagram showing a configuration of a mobile communication system according to an embodiment of the present invention; and

FIG. 5 is a sequence diagram that explains an example of operations of the mobile communication system according to an embodiment of the present invention.

### BEST MODE FOR CARRYING OUT THE INVENTION

Preferred embodiments of the present invention will be explained below in detail with reference to the accompanying drawings.

### EMBODIMENT 1

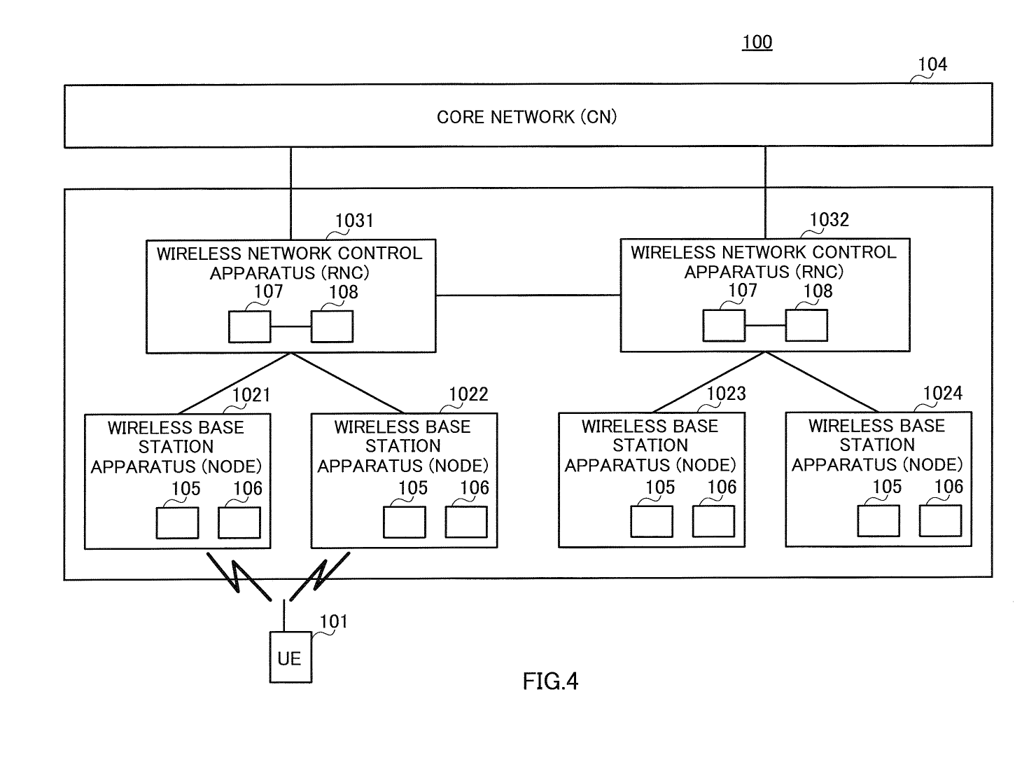

FIG. 4 is a block diagram showing a configuration of a mobile communication system according to an embodiment of the present invention.

As shown in FIG. 4, conventional mobile communication system 100 according to an embodiment of the present invention is equipped with a plurality of mobile communication terminal devices 101, a plurality of radio base station devices 1021 to 1024, and a plurality of radio network control devices 1031 and 1032, and core network 104. In FIG. 4, only one mobile communication terminal device 101 is shown.

Each of the plurality of radio base station devices 1021 to 1024 forms a radio area. Each of the plurality of radio base station devices 1021 to 1024 performs radio communication with mobile communication terminal device 101 positioned in each radio area. Each of the plurality of radio network control devices 1031 and 1032 controls the plurality of radio base station devices 1021 to 1024. Each of the plurality of radio network control devices 1031 and 1032 supplies packets from the plurality of radio base station devices 1021 to 1024 to core network 104. Core network 104 performs position control and call control of mobile communication terminal device 101.

Each of radio base station devices 1021 to 1024 is equipped with retransmission wait cancellation request section 105 and retransmission wait stopping section 106. Retransmission wait cancellation request section 105 transmits a retransmission wait cancellation request to radio network control devices 1031 after continuing to wait for uplink retransmission packets for only the predetermined time until a point before the time the retransmission timeout expiry time passes. Retransmission wait cancellation request section 105 transmits a retransmission wait cancellation request that requests cancellation of the retransmission wait to radio network control devices 1031 before the retransmission timeout expiry time passes during a retransmission wait for uplink retransmission packets. Retransmission wait stopping section 106 stops the retransmission wait of uplink packets when the retransmission wait cancellation acknowledgment that specifies a stop of the retransmission of uplink packets from radio network control devices 103 in response to a retransmission wait cancellation request sent from retransmission wait cancellation request section 105.

Each of radio base station devices 1031 and 1032 is equipped with packet check section 107 and retransmission wait cancellation acknowledgment section 108. Packet check section 107 generates check results by checking whether targeted uplink packets (targeted uplink packets) specified with a retransmission wait cancellation request when a retransmission wait cancellation request is received from retransmission wait cancellation request section 105 of radio base station devices 1021 to 1024 have been received from another radio base station device other than the radio base station device that sent the retransmission wait cancellation request.

Retransmission wait cancellation acknowledgment section 108 generates a retransmission wait cancellation acknowledgment that specifies a stop of the retransmission wait when the check results indicate that the targeted uplink packets have been received from another radio base station device, and transmits the retransmission wait cancellation request to retransmission wait stopping section 106 of radio base station devices 1021 to 1024 that transmitted the retransmission wait cancellation request.

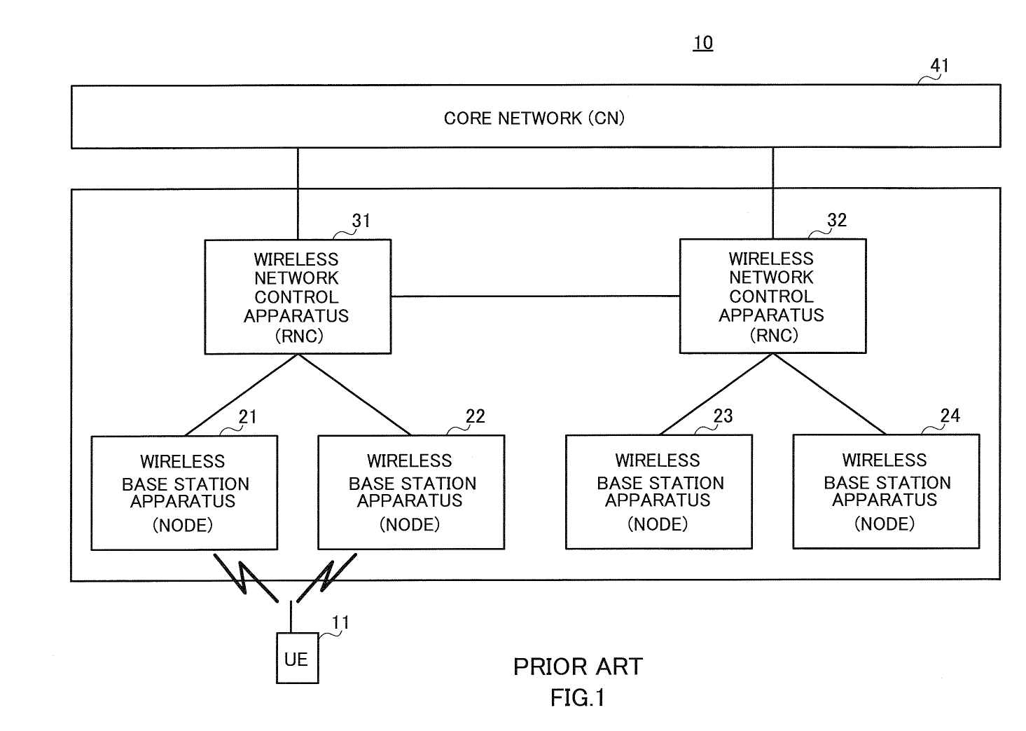

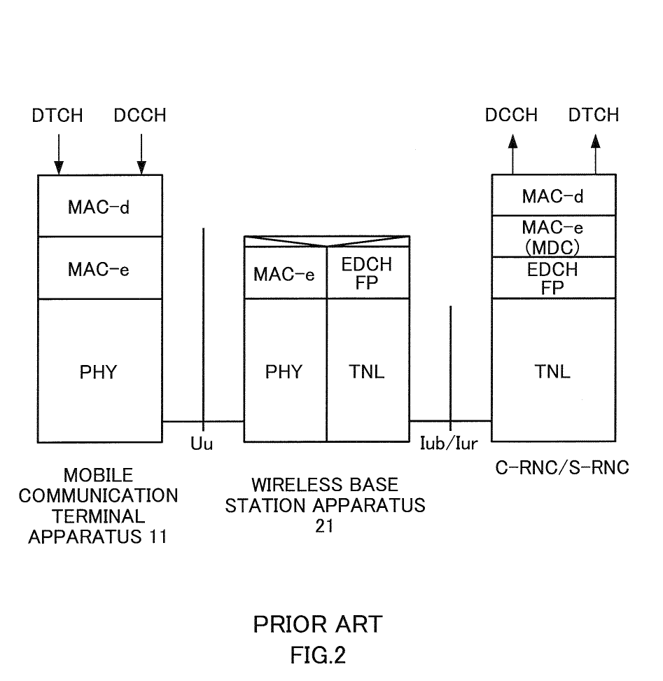

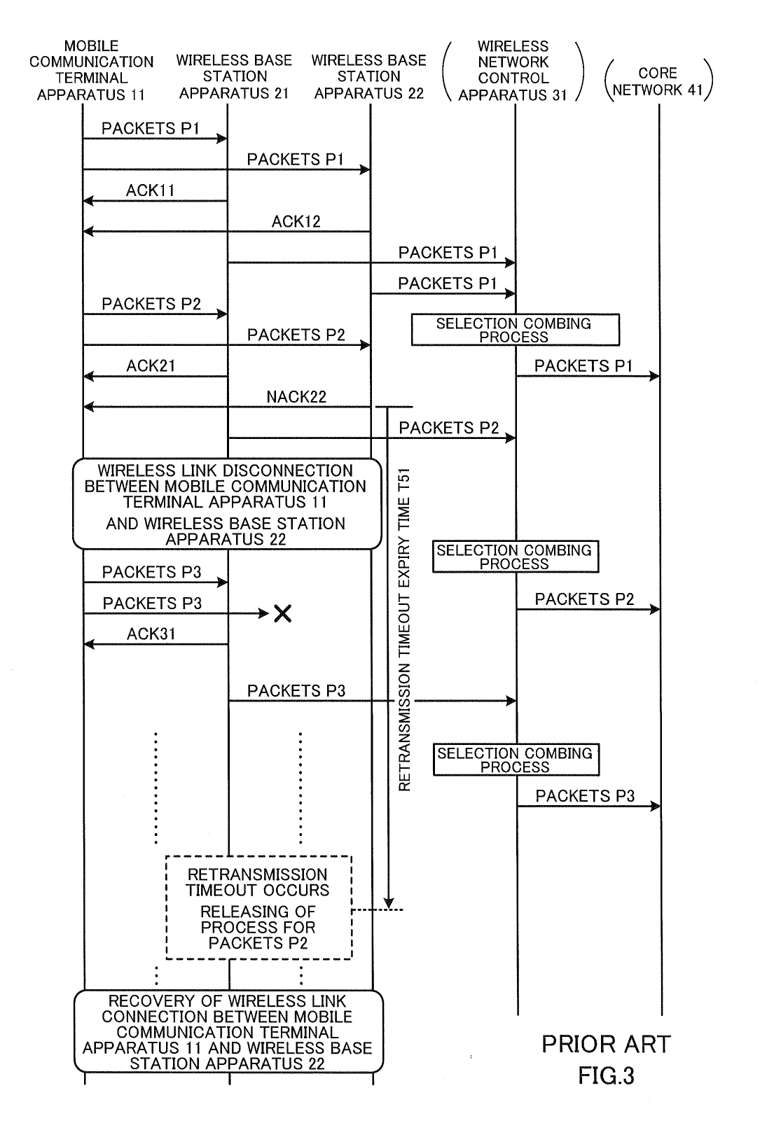

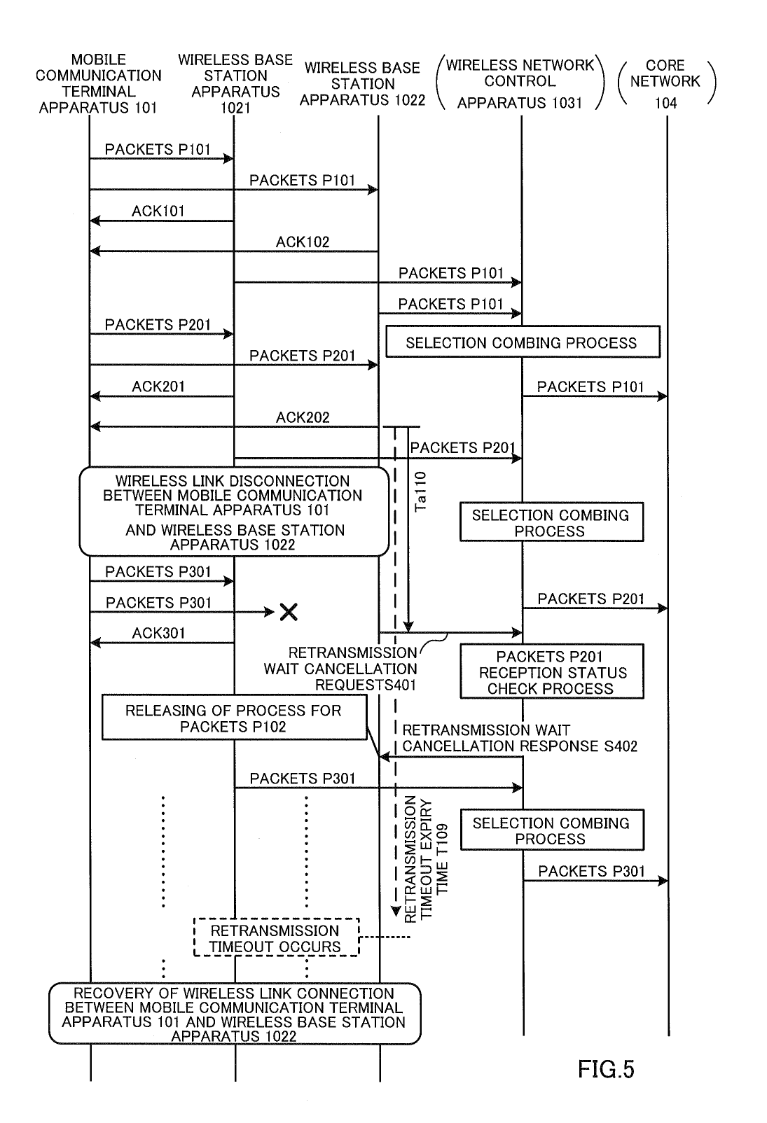

The following will explain an example of mobile communication system 100 according to an embodiment of the present invention with reference to FIGS. 1 to 4. FIG. 5 is a sequence diagram that explains an example of operations of the mobile communication system 100 according to an embodiment of the present invention.

As shown in FIG. 5, when mobile communication terminal device 101 is in a soft hand-over state between radio base station device 1021 and radio base station device 1022, mobile communication terminal device 101 transmits packets P101 to both radio base station device 1021 and radio base station device 1022.

When radio base station device 1021 and radio base station device 1022 receive the packets P101 normally, they transmit ACK101 and ACK102 to mobile communication terminal device 101 and transfer the received packets P101 to radio network control device 1031. When radio network control device 1031 receives the packets P1 from radio base station device 1021 and radio base station device 1022, it transfers the packets P101 to core network 104 upon performing a selection combining process on these packets P101.

Next, when mobile communication terminal device 101 receives ACK101 and ACK102, it transmits packets P201 to both radio base station device 1021 and radio base station device 1022.

Here, if radio base station device 1021 receives the packets P201 normally, but radio base station device 1022 does not receive the packets P201 normally, radio base station device 1021 transmits ACK201 to mobile communication terminal device 101 and transfers the packets P201 to radio network control device 1031.

On the other hand, radio base station device 1022 transmits NACK202 to mobile communication terminal device 101, and, from that point, enters a retransmission wait state for the packets P201 while using process for packets P201. Radio network control device 1031 receives the packets P201 only from radio base station device 1021 but performs the selection combing process targeting only the packets P201 that it could receive, and transfers the packets P201 to core network 104.

Here, if the radio link between mobile communication terminal device 101 and radio base station device 1022 is disconnected, mobile communication terminal device 101 transmits packets P301 to both radio base station device 201 and radio base station device 202 after receiving ACK201 and ACK202. Radiobase station device 1021 processes the packets P301 using the same processes as packets P101 and packets P201.

On the other hand, radio base station device 1022 continues a retransmission wait state for the packets P201, but retransmission wait cancellation request section 105 transmits a retransmission wait cancellation request S401 to radio network control device 1031 at the point the time Ta110 passes without waiting until the retransmission timeout expiry time T109.

When radio network control device 1031 transmits the retransmission wait cancellation request S401, packet check section 107 generates check results by checking whether the targeted uplink packets (targeted uplink data) that are specified with the retransmission wait cancellation request S401 has been received from another radio base station device 1021.

Retransmission wait cancellation acknowledgment section 108 generates the retransmission wait cancellation acknowledgment S402 that specifies a stop of the retransmission wait when the check results indicate that the targeted uplink packets are received from another radio base station device, and transmits it to retransmission wait stopping section 106 of radio base station device 1022.

By this means, when the retransmission wait cancellation acknowledgment S402 is received from radio base station device 1031, radio base station device 1022 ends the retransmission wait for packets P201 and releases the process occupied for the retransmission wait for packets P201.

Note that the time Ta110 can use the time set as a retransmission wait cancellation timer, or the period up to where the process count used in the retransmission wait in radio base station device 1022 exceeds a predetermined threshold. Also, when it is not possible to check that packets P201 have been received from radio base station device 1021 in the reception status check process for packets P201, radio network control device 1031 does not generate a retransmission wait cancellation acknowledgment S402 that specifies a stop of the retransmission wait for packets P201, and generates a retransmission wait acknowledgment that specifies a continuation of the retransmission wait and transmits it to radio base station device 1022.

Note that the present invention includes a mobile communication program that executes the aforementioned operations in the mobile communication system according to the embodiment of the present invention.

The present application is based on Japanese patent application No. 2004-271893, filed Sep. 17, 2004, the entire content of which is expressly incorporated herein by reference.

### INDUSTRIAL APPLICABILITY

The present invention provides an advantage of improving throughput, and is useful in a mobile communication system, a radio base station device, radio network control device, and mobile communication method.

1. A mobile communication system comprising:
a plurality of mobile communication terminal devices;
a plurality of radio base station devices that perform radio communications with the mobile communication terminal devices; and
a radio network control device that controls the plurality of radio base station devices, wherein:
the radio base station devices transmit a retransmission wait cancellation request that requests a cancellation of a retransmission wait before a retransmission timeout expiry time passes during a retransmission wait for uplink retransmission packets, and stops the retransmission wait upon receiving a retransmission wait cancellation acknowledgment that specifies a stop of the retransmission wait; and
the radio network control device transmits the retransmission wait cancellation acknowledgment to a radio base station device that transmitted the retransmission wait cancellation request when an uplink retransmission packet specified by the retransmission wait cancellation request has been received from another radio base station device other than the radio base station device that transmitted the retransmission wait cancellation request.

2. A radio base station device comprising:
a retransmission wait cancellation request section that transmits a retransmission wait cancellation request that requests a cancellation of a retransmission wait before a retransmission timeout expiry time passes during a retransmission wait for uplink retransmission packets; and
a retransmission wait stopping section that stops the retransmission wait upon receiving a retransmission wait cancellation acknowledgement that specifies a stop of the retransmission wait in response to the retransmission wait cancellation request transmitted by the retransmission wait cancellation request section.

3. A radio network control device comprising:
a packet check section that, upon receiving a retransmission cancellation request that requests a cancellation of a retransmission wait for uplink retransmission packets, checks whether a packet specified by the retransmission wait cancellation request has been received from another radio base station device other than the radio base station device that transmitted the retransmission wait cancellation request; and
a retransmission wait cancellation acknowledgment section that transmits a retransmission wait cancellation acknowledgment that specifies a stop of the retransmission wait to the radio base station device that transmitted the retransmission wait cancellation request when the packet check section checks that the uplink retransmission packet has been received from another radio base station device.

4. A mobile communication method comprising:
transmitting from a radio base station device a retransmission wait cancellation request that requests a cancellation of a retransmission wait before a retransmission timeout expiry time passes during a retransmission wait for uplink retransmission packets;
receiving at a radio network control device the retransmission wait cancellation request and checking whether an uplink retransmission packet specified by the received retransmission wait cancellation request has been received from another radio base station device other than the radio base station device that transmitted the retransmission wait cancellation request;
transmitting, when it is checked that the uplink retransmission packet has been received from the another radio base station device, from the radio network control device a retransmission wait cancellation acknowledgment that specifies a stop of the retransmission wait to the radio base station device that transmitted the retransmission wait cancellation request; and
receiving at the radio base station device the retransmission wait cancellation acknowledgment and stopping the retransmission wait.

5. A mobile communication program for executing the steps of:
transmitting from a base station device a retransmission wait cancellation request that requests a cancellation of a retransmission wait before a retransmission timeout expiry time passes during a retransmission wait for uplink retransmission packets;
receiving at a radio network control device the retransmission wait cancellation request and checking whether an uplink retransmission packet specified by the received retransmission wait cancellation request has been received from another radio base station device other than the radio base station device that transmitted the retransmission wait cancellation request;
transmitting, when it is checked that the uplink retransmission packet has been received from the another radio base station device, from the radio network control device a retransmission wait cancellation acknowledgment that specifies a stop of the retransmission wait to the radio base station device that transmitted the retransmission wait cancellation request; and
receiving at the radio base station device the retransmission wait cancellation acknowledgment and stopping the retransmission wait.
